(19) United States
(12) Patent Application Publication
(10) Pub. No.: US 2013/0218788 A1
(43) Pub. Date: Aug. 22, 2013

(54) SYSTEM AND METHOD FOR MONITORING CREDIBILITY OF ONLINE CONTENT AND AUTHORITY OF USERS

(71) Applicant: Factlink Inc., (US)

(72) Inventor: Merijn Terheggen, Alameda, CA (US)

(73) Assignee: FACTLINK INC., Alameda, CA (US)

(21) Appl. No.: 13/770,994

(22) Filed: Feb. 19, 2013

Related U.S. Application Data
(60) Provisional application No. 61/600,694, filed on Feb. 19, 2012.

(51) Int. Cl. G06Q 30/00

(52) U.S. Cl. CPC G06Q 30/018
USPC 705/317

(57) ABSTRACT

A computer-implemented system and method for generating and publishing fact links, which can be provided in connection with assertions and other elements of a content item. The fact links can enable a forum in which a population of users can comment on the credibility or veracity of an assertion or other element of the content item.

### RELATED APPLICATIONS

This application claims benefit of priority to Provisional U.S. Patent Application No. 61/600,694, filed Feb. 19, 2012, entitled SYSTEM AND METHOD FOR MONITORING CREDIBILITY OF ONLINE CONTENT AND AUTHORITY OF USERS; the aforementioned priority application being hereby incorporated by reference in its entirety for all purposes.

### TECHNICAL FIELD

Embodiments described herein relate to online content publishing, and more specifically, to a system and method for monitoring credibility of online content and authority of users.

### BACKGROUND

Online publishing is prevalent in many forms and outlets. Currently, for example, it is common for online articles (e.g., news stories, blogs) to include comments and other user generated content. Many times, such content can be carried over to social media (e.g., TWITTER). Moreover, content items can be reprinted or republished in various context, including social media.

The sources for content are pervasive, and while content is more readily viewable and shared, the standards for maintaining credibility and authority lag that which is often present in print media. For example, in print media, professional journalist and commentors often research storylines and publish stories with the publishing source and authors reputation serving as one source of credibility. In peer reviewed journals, formal review, references and citations play an even greater role in establishing credibility of content and stature for authors. In contrast, in the online realm, commentors are often not trained professionals, and many commentors are often anonymous. A far greater number of persons can publish views with little adherence to standards such as fact-checking. Furthermore, many have not had the formal training or do not have the time and resources required to deliver content that is up to par with quality journalism or scientific methodologies.

Moreover, any published content can be readily searched, given that much online content is indexed. Even content which has been discredited or shown to be factually incorrect can live on and gain “truth” in cyberspace by being reprinted and re-stated.

### BRIEF DESCRIPTION OF THE DRAWINGS

FIG. 1A illustrates a client side system for enabling a user to evaluate the credibility of a statement or assertion in an online medium.

FIG. 1B illustrates a network side system for providing a service that enables creation, viewing and use of fact links and other feedback, according to one or more embodiments.

FIG. 2A-FIG. 2I illustrate examples of how a fact links can be created, according to various aspects.

FIG. 3A illustrates a user account page maintained at a service such as described with an example of FIG. 1B.

FIG. 3B to 3E illustrate a user assigning a fact link 132 to a particular channel (or topic).

FIG. 4A through FIG. 4G illustrate various examples of interfaces for enabling a user to interact with a fact link or service providing the same.

FIG. 5A-5I illustrate examples in which evidence can be provided to support or weaken a fact link.

FIG. 5J illustrates a variation in which fact links can be combined with arguments.

FIG. 6 illustrates a method in which a fact link can be created for a content item, according to an embodiment.

FIG. 7 illustrates a method for providing fact links to a population of users, according to an embodiment.

FIG. 8 illustrates an example of a computing system on which one or more embodiments described herein can be implemented.

### DETAILED DESCRIPTION

Embodiments described herein enable users to provide feedback for content items in the form of a data item, termed herein a fact link, that can be associated with a content item, and more specifically, with a specific component of a content item that conveys an assertion (e.g., a phrase, quote, sentence or paragraph or image). The fact links can be dynamic, in that various users in a given population can view the fact link with the content item, and each of the users can add to the fact link by way of feedback, comments and additional fact links. Thus, the fact links can generate a log of activity that indicates the credibility or veracity of an assertion, as well as supporting views or counterpoints to the assertion.

In some examples, a computer-implemented system and method is provided for enabling creation and publication of fact links. A system, for example, can be configured to enable individuals to create fact links in connection with content elements that correspond to assertions (e.g., statements). The fact links can enable a forum in which a population of users can comment on the credibility or veracity of an assertion or other element of the content item.

In examples described herein, the fact link is provided as a dynamic data item that is spatially adjacent or near the specific component that is the assertion. For example, fact links can appear as annotations when viewed with text content. Still further, in some implementations, the fact links can be generated as content elements that exist independently of the subject content item (e.g., text article that contains the subject assertion), or which supplement or augment the content item. Moreover, the fact links can be provided in multi-modal form. For example, fact links can be hidden, minimized (e.g., present and selectable) near an assertion or content element, or expanded, and when expanded the fact links may be navigated or scrolled.

Examples described herein provide for a computer-implemented system or method in which online content can be monitored. In one implementation, a user can interact with a content item. In response to the user interacting with the content item, a user interface feature is generated that enables the user to provide feedback regarding the user's belief in the veracity or credibility of the assertion. A fact link is created that associates the feedback with the assertion. The fact link can be stored and published with the content item. Additionally, the fact link can be made interactive, to enable other users in a population of users to provide feedback on the assertion, the fact link or comments/feedback to the fact link.

Still further, in some examples, content can be published with fact links that indicate the credibility of the content item or its elements. In an example, a fact link can be linked to a content item, and the fact link can be associated with an assertion or other content element included with the content item. The fact link can be provided with the content item, so that the fact link can be viewed adjacent or near the assertion of the fact link. The fact link can be made to be interactive, so that viewers can provide feedback by interacting with the fact link.

Still further, examples described herein include a system and method for enabling monitoring of credibility in online content and authority of users. In an embodiment, a user is enabled to select a content element (e.g., text such as sentence or paragraph) in an article. For example, the content element can correspond to a sentence, phrase or paragraph that includes an assertion of opinion or fact from an author. In an embodiment, a user interface feature is generated that enables the user to enter feedback regarding the user's belief in the veracity or credibility of the assertion. A set of data, termed a fact link, can be created that associates the content element with the feedback. The fact link can be stored in an online medium accessible to others.

In embodiments, articles or news stories can be rendered in a form that is fact linked. More specifically, an article can be rendered in a manner that enables fact links provided by users of an online community to be rendered with the article. The fact links can be based on, for example, sentences in the article, and reflect a community's evaluation on the accuracy of the assertion in the article.

Among numerous other aspects, one technical effect that is provided is that information pertaining to opinion and fact, as recorded in an online medium, can condensed and totaled for the user in context of a relevant element of content. When conventional approaches provide a single dimension of information, examples as described provide multiple dimensions, in that content elements such as sentences or paragraphs can be logically and visually linked to other feedback and comments in a manner that consolidates and totals various information from numerous sources relating to the underlying element.

System Architecture

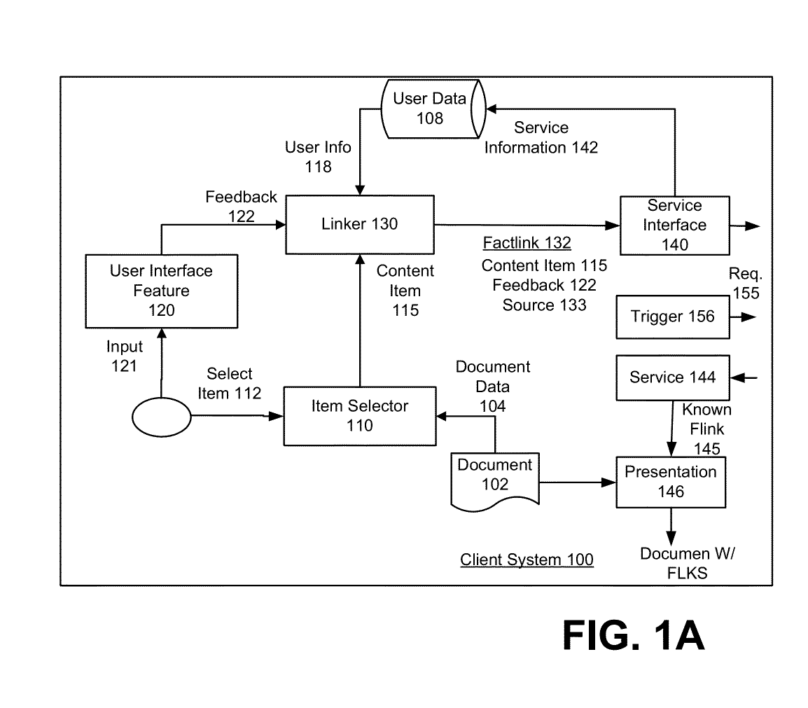

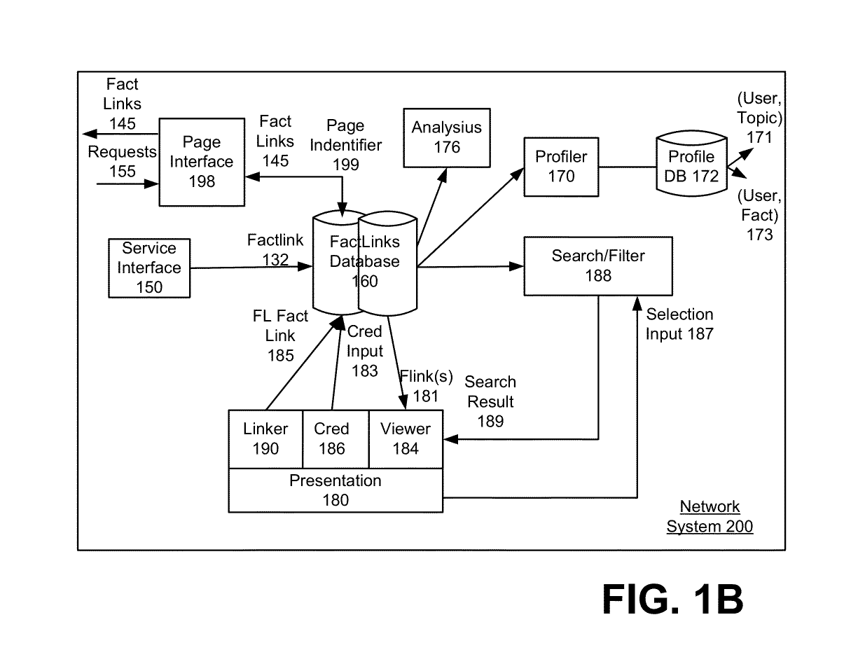

FIG. 1A illustrates a client side system for enabling a user to evaluate the credibility of a statement or assertion in an online medium. A system such as described with an embodiment of FIG. 1 can be implemented as, for example, an application (e.g., web browser other application that renders network content), through the execution of scripts or other programming received from an online source, and/or as a plug-in (e.g., browser plug-in). System 100 can be implemented on a computer or computing device of a user. According to embodiments, system 100 can be implemented on, for example, a personal computer (e.g., laptop or desktop), a tablet or a mobile computing device. Other computing devices or platforms on which system 100 can be implemented include, for example, a gaming station or web-enabled appliance.

In an embodiment, system 100 includes item selector 110, user interface feature 120, linker 130, and service interface 140. The system 100 may be operated as (or in connection with) an application that renders a document 102. The document 102 can correspond to, for example, a web page that is rendered through a browser. In variations, the document 102 can be a local document (e.g., text document), image file, application page or similar content item. Still further, in some variations, the functionality described by system 100 can be implemented as part of, or through a browser that renders the web page.

The item selector 110 includes functionality to enable the user to provide selection input 112 that specifies an element from content item 104 of the document 102. In an embodiment, a user can select elements corresponding to sentences or phrases from the document 102. In variations, the user can select a content element corresponding to an image. The content element can convey or represent an assertion (e.g., an opinion, a statement of alleged fact, an image that conveys a message). In some examples, the item selector 110 can be integrated into functionality available through, for example, the operating system of the computing device, or through an application (e.g., web browser, web-based application, etc.). For example, the item selector 110 can be integrated as a highlight feature that can highlight or otherwise select a sentence from the document 102. For example, the user can specify selection input 112 using a mouse or other pointer device, similar to highlighting text in other applications.

According to some embodiments, the functionality of system 100 can be structured to cause the computing device on which system 100 is implemented to trigger added functionality when the selection input 112 is provided from the user. Thus, the item selector 110 can be used to select a content element, such as a sentence. Upon selection, additional functionality of the system 100 is triggered.

In an embodiment, selection input 112 triggers, or otherwise enables a user interface feature 120 that can receive user input with respect to the selected content element 115. In one implementation, the user interface feature 120 can prompt the user into specifying an input regarding a relevant opinion or belief of the user with respect to the selected content element 115. In one embodiment, the user interface feature 120 can enable the user to provide input 121 in the form of feedback 122 as to whether the user agrees or disagrees to the assertion of the selected content element 115. For example, the feedback 122 can be binary (“agree” or “disagree”), tri-nary (“agree” “disagree” and “neutral”), quantitative (e.g., score or ranking) or qualitative (e.g., commentary). The feedback 122 can convey whether the user believes the assertion is true or false, and/or the degree to which the user agrees or disagrees with the assertion of the element 115. By way of specific examples, the feedback 122 that can be specified by the user can be textual (e.g., “agree” or “disagree” or commentary), numeric or graphic.

The linker 130 operates to associate the feedback 122 with the selected content element 115. Additionally, the linker 130 associates the feedback 122 with the content item 104 that carries the element 115 subjected to user feedback. In one implementation, the linker 130 maintains a map of the content item 104. For example, in the example of a web page, the linker 130 can utilize the document object model (DOM) for the page, and further tokenize the text elements of the page so that the individual works or sentences can be selected or specified as content elements 115. The linker 130 communicates the combine data item (fact link 132) to the service interface 140. In this way, the fact link 132 can specify the content element 115 and the feedback 122. Additionally, the linker 130 can associate the user information 118 (which can be stored in a user data store 108 (e.g., cookie)) with the feedback 122 and the selected content element 115. The user information 118 that is provided with the fact link 132 can identify the user, either by identity, through a moniker or online personna, or anonymously. The user information can serve to associate the user's identifier to other users of client system 100. As described below, the user's feedback 122 can, for example, provide a basis for the user to establish credibility for online activities, such as provided through a service of the network system 200 (see FIG. 1B). The fact link 132 can also specify the source 133 (e.g., web page) that provide the content element 115 (e.g., web page that is rendered through browser).

In variations, the contents of the fact link 132 (e.g., information linked or provided with the fact link data structure) can include data from external sources. For example, the fact link 132 can include a widget or script that retrieves real-time information from a third-party source (e.g., stock market) and displays the information as part of the fact link 132. Moreover, some data in the fact link 132 can also be updated using formulas (e.g., count days until election). When the fact link 132 is stored (and subsequently rendered, as described below), the data can be updated so that recent data is displayed with the fact link. Comments to the fact link 132 can also include such information.

Still further, fact links 132 can also include logic, such as a script, which can, for example, user real-time information to input data and make decisions regarding what information to display or what status/credibility to assign with a given assertion, fact link or comment.

The service interface 140 can communicate the fact link 132 to network system 200, such a illustrated by an embodiment of FIG. 1B. The network system 200 can communicate information 142 back to the system 100, operating on the user's computing device. The information 142 can include information about the user's interactions with the service 150 (e.g., information about the user's fact links 132), as well information about other fact links from other users. Optionally, the information received from the network system 200 can be stored in the user data store 108. Thus, the user can, for example, have a local copy of some information or data relating to the user activities, such as a local store of all feedback the user has received to one of the user's fact links 132.

FIG. 1B illustrates a network side system for providing a service that enables creation, viewing and use of fact links and other feedback, according to one or more embodiments. A system 200 such as shown by an embodiment of FIG. 1B may be implemented in connection with a system such as described with an embodiment of FIG. 1A. For example, a client computer may create and communicate a fact link through service 200. Additionally, a client computer can render documents that include fact links by communicating with the service 200.

According to an embodiment, system 200 includes service interface 150 to handle communications with various client devices that generate and communicate fact links 132. Accordingly, system 200 can be implemented on a server, or combination or servers, that provide services such as website or web content, and/or resources for web-based applications. The system 200 can further include one or more databases 160 to store newly created fact links 132, as received from the client system 100. A presentation component 180 enables users of system 200 to view and interact with stored fact links 181, created by users in the population that utilize the network system 200. In one implementation, functionality and data (e.g., stored fact links) of system 200 can be directly accessed through a website or application (e.g., web-based application). In variations, the presentation component 180 can be implemented through a third-party web page. For example, the presentation component 180 can operate in cooperation with a script that runs through the browser of users. When a given web page is rendered, the script can access and implement functionality provided by the presentation component 180 as described below.

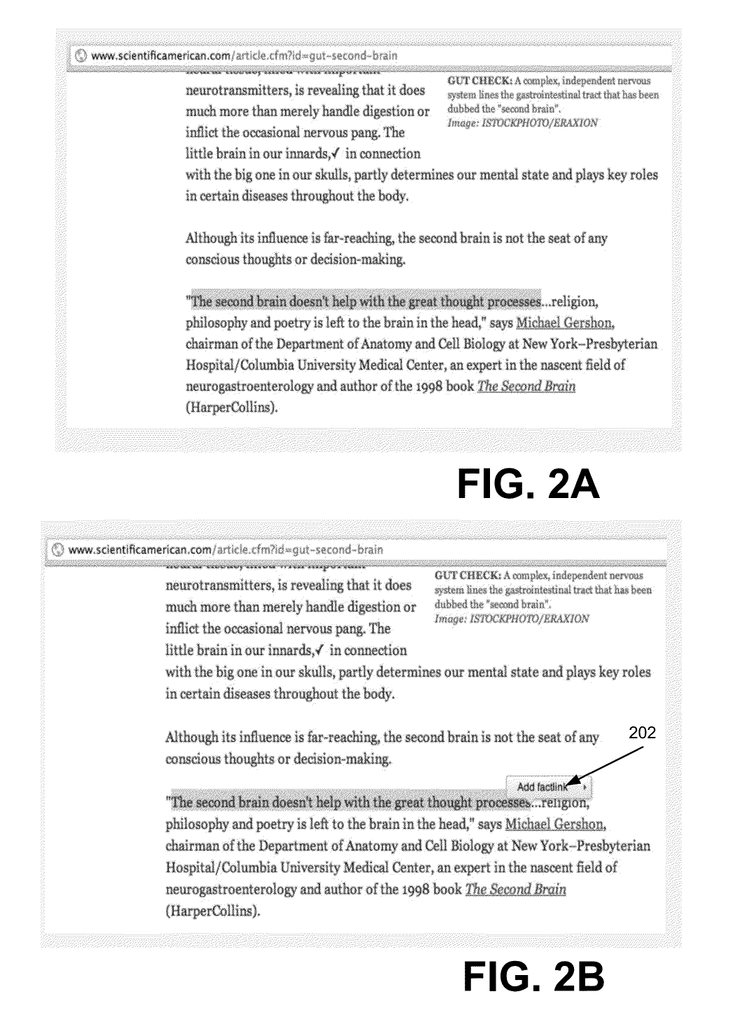

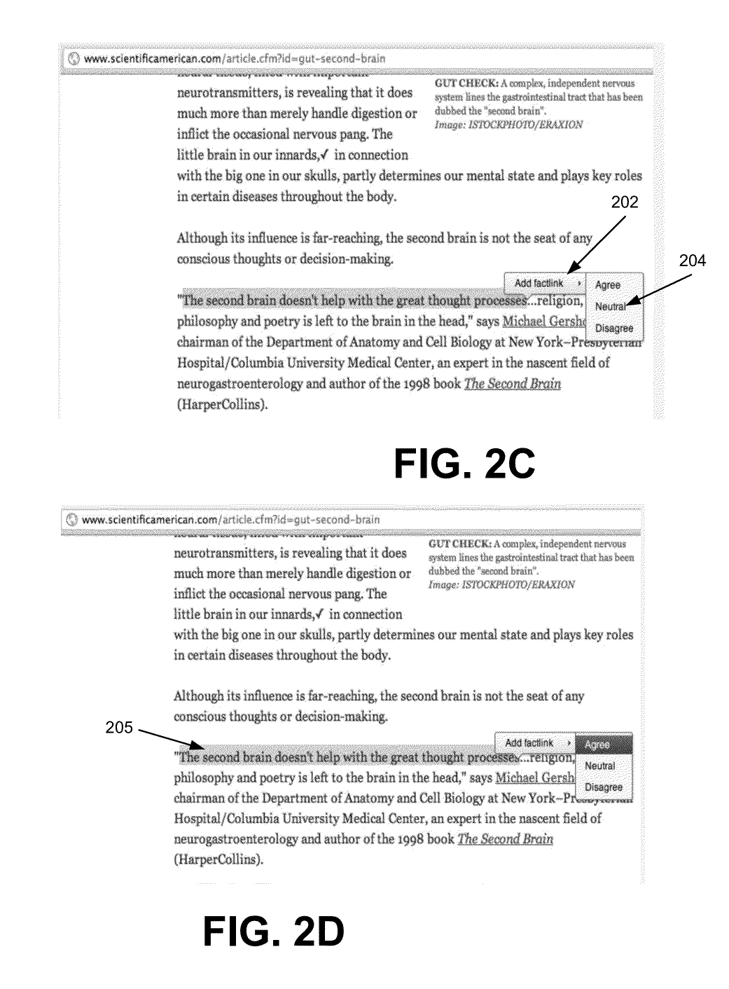

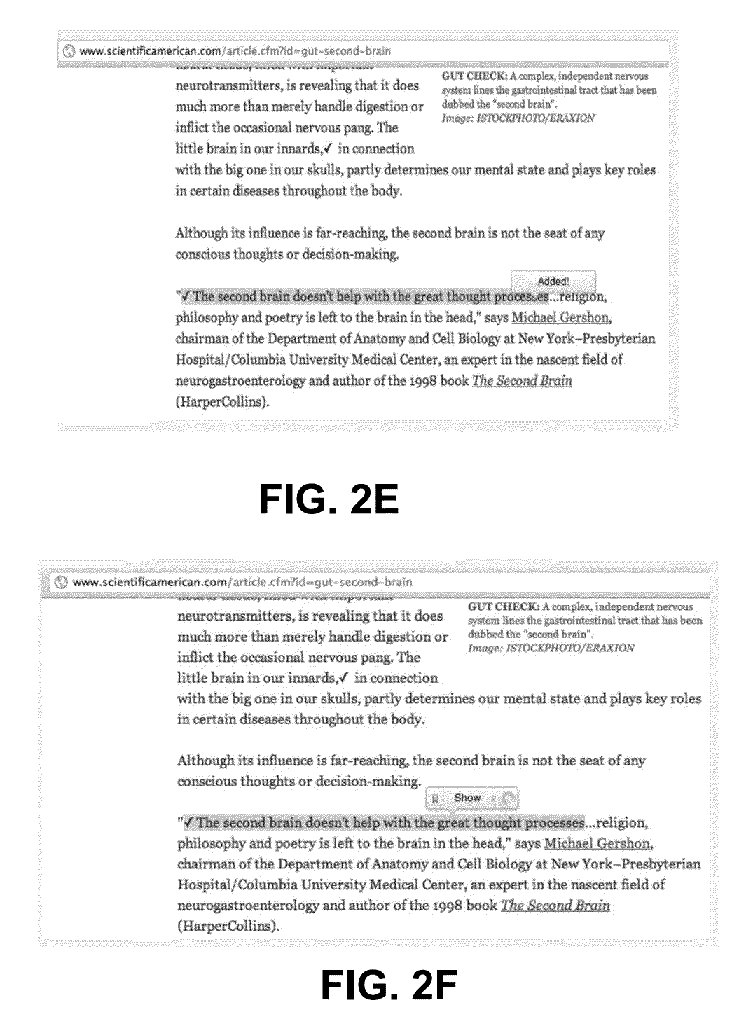

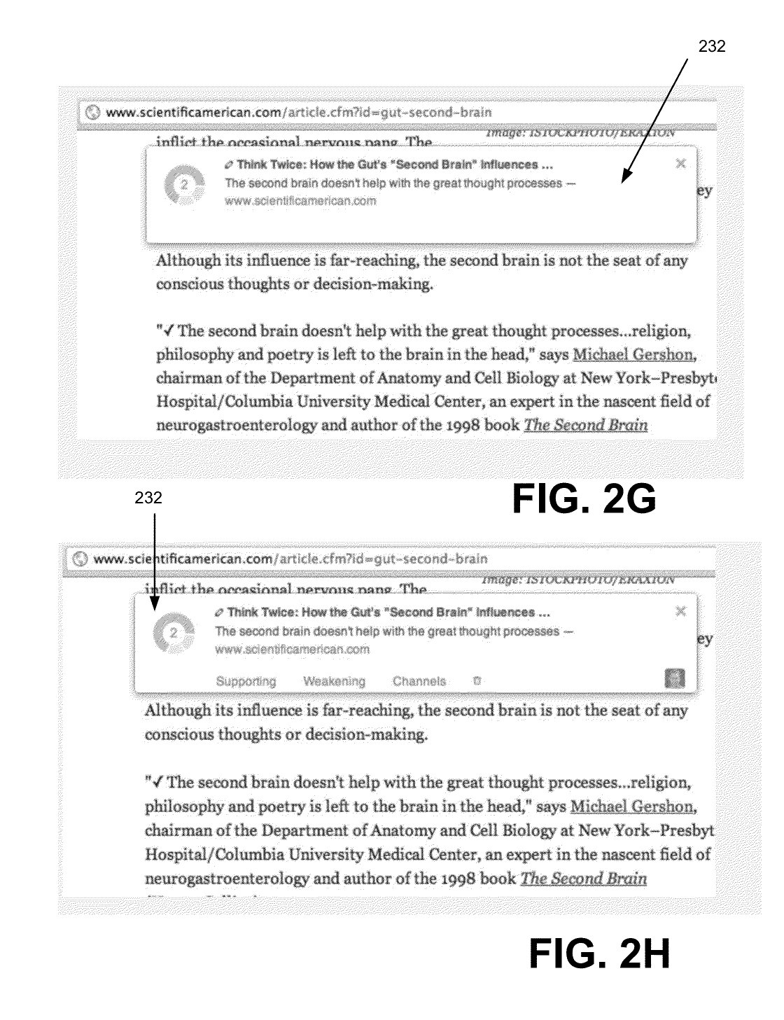

In an example of FIG. 2, the service interface 150 can communicate with one or more client systems 100 to receive newly created fact links 132. The newly created fact links 132 can be stored in the databases 160 and subsequently rendered to the population of users stored fact links 181.

According to embodiments, the network system 200 provides individuals with ability to view stored fact links 181 created by various users. In one implementation, for example, service 200 is provided through a website, which enables individuals to login and view their stored (or previously created) fact links 181, as well as view fact links 181 generated by other users. A user can view the stored fact link 181 of another user for purpose entertainment, research, discussion and further commentary. The viewing of other fact links can be active (e.g., user scrolls through fact links specifically) or passive (user views fact links when viewing other content, such as a web page). Thus, for example, the presentation component 180 can be provided as part of a web page.

A service provided through system 200 can include functionality for enabling the users of the service to interact with fact links, for purpose of commenting, providing feedback, developing their own authority (e.g., how credible that user's comments are) or that of others, and/or generating additional fact links based on their own input. The stored fact links 181 can be accessed from the database 160 directly (e.g., the user seeks fact links) or indirectly. In the latter case, the user may view content that includes stored fact links 181.

According to an embodiment, the presentation component 180 can include or provide a credibility interface 186, a viewer 188, and a linker 190. In an embodiment, a user can view one or more previously created fact links 181 through a viewer 184 of presentation component 180. As described with some embodiments, the rendered fact links 181 can display various information, including, for example, the user who created the fact link 181 being viewed, the statement or other content item, that user's and other users' linked feedback to the underlying content item, and optionally a link to a source of the underlying content. For example, the user of system 200 can view previously created fact links 181 generated by the user of system 100. The identity of the user that created an individual fact link 181 can correspond to, for example, that user's online personna.

As additions or variations, the viewer 184 can display fact links 181. Various presentation formats can be used for the display of fact links. In some implementations, for example, fact links can be displayed in the form of topical channels. Fact links from a population can be filtered or sorted by topic. Furthermore, in some embodiments, each channel can provide or display fact links that, for example, (i) originate from a particular user or class of users, (ii) include commentary from particular persons, (iii) share a particular topic or category (e.g., source document is of a specific category), (iv) are sorted by popularity, recency or other filtering parameters. In an embodiment, a search/filter component 188 provides results 189 for viewer 184. The search/filter component 188 can receive search or selection input 187 from the user (e.g., fact links about a specific subject, or which contain a particular word, originate from a particular user etc.) and perform matching, similarity comparisons or other search operations on the database 160 in order to identify a set of fact links as part of the search result 189. In variations, the search result 189 can include fact links and related comments as suggestions or recommendations. The suggestions can originate from, for example, other users whom are followed or are followers. Recommendations may be made programmatically based on the user profile, as compared to other user profiles.

In addition to viewing their own previously created fact links 181, an embodiment enables the user to interact with the presentation component 180 to view the fact links 181 generated from other users in a population of users. The presentation component 180 also enables to provide input or feedback. Various kinds of input or feedback can be provided from the users of the service. In some implementations, the user can provide feedback that corresponds to (i) feedback about the underlying content item (e.g., content element 115 of FIG. 1A), (ii) feedback about the feedback (e.g., feedback 122 of FIG. 1A) portion of the fact link 181 (e.g., one user may disagree about another user's disagreement about the content item 122), (iii) commentary or other feedback about the credibility of the content item 122, the source of the content item, or the user who provided the fact link. The user of system 200 can enter feedback using a credibility interface 186. As an addition or variation, the user can create a fact link off a fact link 181. For example, when the user expresses his agreement or disagreement with a fact link (e.g., either the content item 122 or the feedback provided with it), the user's identifier (e.g., name or personal identifier) may be used to generate a new fact link off the existing fact link 181 that was being viewed.

In one embodiment, the presentation component 180 includes an interface to enable the user of system 200 to provide credibility input 183. By providing credibility input 183, the user can specify whether the user of system 200 agrees or disagrees with, for example, the user generated portion of the fact link 132 (e.g., feedback 122). If the user disagrees (or provide, for example, numeric input indicating disagreement) with, for example, the feedback portion of the fact link 181 that is under viewing, that user can specify input that indicates the particular user's disagreement with one user's feedback. The credibility input 183 can be stored in the database 160. Furthermore, a value can be associated with the input that scores the overall credibility of the fact link 181 based on credibility input 183 from every user that provides such input for that fact link 181. As an addition or variation, the credibility input 183 can affect a credibility score of the original person who created the fact link 181 (e.g., user of system 100). Thus, persons who create fact links 181 can receive an online reputation that is based on a metric corresponding to the positive and/or negative credibility inputs 183 their fact link receives over time.

As an addition or variation to providing credibility input, the user of service 200 can create a separate fact link with his or her input to another fact link. For example, the user can provide input where the agrees with the feedback 122 included as part of a particular fact link 181. In an embodiment, linker 190 generates a separate fact link (“FL fact link”) 185 in which (i) the content item of the fact link is another fact link, and (ii) the feedback portion of the new fact link is he opinion of the user as to the credibility or veracity of another user's opinion (e.g., regarding the underlying content item, such as a phrase from a news story).

A profiler 170 can tabulate and determine credibility metrics based on the various feedbacks supplied with individual fact links 181 of the database 160. A profile database 172 can retain information used by the profiler 170 to determine credibility, as well as to store authoritative information of individual users. According to embodiments, the profiler 170 can generate authority scores or metrics for commentors that create fact links, sources of content items (e.g., websites or publishers), authors, specific phrases or sentences that appear in a given article (e.g., assertions of facts, opinions etc.), and/or articles that have been fact linked by users of system 200. The credibility scores can, for example, assign values to positive or negative feedback, as well as to neutral feedback. In some variations, the feedback provided from users in the fact link can be a score, rather than textual, and such scores can be tabulated to determine a credibility score. The credibility metrics may be weighted based on design parameters, such as weighting negative feedback more than positive feedback. Still further, the credibility score may count credibility input (or feedback) from some users (e.g., credible or frequent users) more than those of other users. Other variations for maintaining credibility scores can also be used. The various credibility scores may be maintained in database 160, in association with the particular user, phrase, source and/or article.

The profiler 170 can also tabulate and determine authority of users on fact links, topics, sources of content items, etc. This authority can be based on activity on those fact links, topics and sources. In some implementations, users authority can be topic specific. For example, the profile store 172 can store authoritative indicators (e.g., scores) as tuples 171 (user, topic). This metric would allow users to have authority for certain topics, and no or little authority for others. As an addition or alternative, the profile store 172 can maintain other metrics, such as tuples regarding the authority of the user (e.g., tuple 173 (user, fact)). If a user is very credible on a factual item, he may have more authority in a general sense, as well as heightened authority for a subject of the fact. Numerous variations to metrics (or tuples) as described can be selected as a matter of design and implementation.

Among other tasks, the profiler 170 can control or otherwise use processes that determine authoritative metrics for individual users. In one aspect, the profiler 170 utilizes programmatic monitors that indicate activity amongst a population of users with respect to a specific fact link, and more specifically, activity that indicates the particular fact link is useful. For example, if a particular fact link draws a lot of commentary, is a basis for other fact links, or has multiple commentators, then the activity can be used as a metric to indicate that the fact link is credible or controversial. Moreover, the strength of the credibility can be based on the amount of user interaction. Credibility can also be influenced by the authority of those users who interact with a particular item. For example, highly authoritative persons can have activity relating to a specific fact link, and this activity can be weighted (because of the credibility factor of the users) to increase the authority of the user or the particular fact link.

One or more analysis component 178 can be coupled to the fact links database 160 in order to analyze stored fact links and information included with stored fact links. Among determinations that can be made, analysis component 178 can determine whether two or more fact links are related to one another. Fact links can be linked to one another as being related by subject matter, for example, or opinion. For example, fact links can be related to one another if those fact links are cited with one another repeatedly by different users.

Still further, as an alternative or addition, the profiler 170 can dynamically maintain and adjust an authoritative score of individual users. For example, when users create a fact link, the reception of the fact link can be scored. Additionally, other user activity, such as when users comment, support/discredit or create fact links in response to other fact links can also be detected or monitored, then scored. In some implementations, the profiler 170 maintains a set of rules for scoring the authority of users based on various activity (e.g., create new fact link, create fact link on fact link, comment), as well as reception to their activity (e.g., comment or feedback to newly created fact link or to fact link on fact link, etc.). As mentioned, the authority of the users can be both general and subject specific. For example, a user can be deemed an authority (e.g., highly credible) in one topic, but not another. In some implementations, users can become credible in topics without direct activity, based on the reception of the fact link or user activity. For example, a user can create a new fact link for a particular topic (e.g., medicine) and have it reprinted in context of a topic that is not directly related to the original topic (e.g., sports). To extend the example, it may be possible for the user to gain authority in sports or sports medicine, based on the user activity with medicine.

The profiler 170 can enable various interfaces to visually represent the credibility of the user, either generally or in connection with specific topics. For example, geometric shapes such as circles representing topics can be sized to illustrate what a given user is credible in.

As an addition or alternative, the one or more analysis component 178 can determine metrics that impact or determine credibility of a particular fact link. For example, the analysis component 178 can process rules that assign more credibility (e.g., add credibility score) to a particular fact link in response to certain conditions, such as the occurrence of other users agreeing with the fact link, other users adding information for the fact link, or still further other users adding other fact links to the fact link (particularly when the added fact link it even more credible or from an authority). Additional factors that influence the credibility of the fact link can include the authority of those persons who commented or endorsed the fact link, as well as negative credibility as a result of discredited or negative feedback to the fact link.

The analysis component 178 can also determine metrics which independently indicate the credibility (or veracity) of a given fact link. For example, the fact link can receive feedback as to being true or false from a population of users (e.g., users can select agree or disagree), and the feedback can be tallied. If 90%, for example, think a statement is true, the fact link can be deemed credible, while a 60% metric may indicate the fact link is more controversial. But even more controversial fact links can be credible if they have a large count. For example, if 10000 persons provide feedback for a particular fact link, and only 60% think its credible, that is still 6000 individuals who think the fact link is true. This may result in the fact link being scored as credible. Additionally, rules or logic can be used to weight feedback. For example, feedback from those users who have authority can count more than feedback from those who don't-thus, if the fact link has a large number of tallies from non-authoritative commentators as to one viewpoint (e.g., not credible), the fact link can still be deemed in a manner that is contra if a smaller number of authoritative users have the differing view.

In some variations in which real-time data or logic is utilized with widgets, both the analysis component 178 and the profiler 170 can utilize the real-time data or logic in performing their respective operations. For example, the authority of the user who created the fact link can hinge on whether a prediction comes true (e.g., stock market price). The profiler 170 may determine credibility at different instances of time (e.g., daily), and the determination made on one day may be different than the determination made on another day based on the updates to the data and/or the logic included with the stored fact link.

In some variations, the authors who generate assertions from which fact links are generated can also be evaluated for credibility, even if such authors are not users of the system. In one implementation, the analysis component 178 incorporates analysis relevant to the underlying assertions, such as in the form of whether the fact links generate tallies to support or weaken the author's statements. Thus, in some variations, the authors can be evaluated for authority much like users who provide the newly created fact links 132.

As an addition or alternative, the analysis component 178 can analyze the stored fact links 181 for relevance of facts links relative to one another, and not necessarily in view of the underlying statement. For example, stored fact links 181 can be analyzed to determine if the underlying statements were from the same author (of the content element). Fact links 181 can also be analyzed to determine if they pertain to a same fact, same opinion, or more generally to a same subject. The identification of related fact links 181 can be used in various context. For example, fact links can be displayed in the context of channels, or in linked fashion (based on authorship or subject matter). Furthermore, the display of one fact link can enable viewing of other fact links that are deemed related as provided above.

Referring to FIG. 1A and FIG. 1B, some examples provide that the service 200 can be used to render documents (e.g., web pages) in a manner that displays fact links already associated with particular aspects of the article. According to an embodiment, client system 100 can include a trigger 156 which executes to identify the document 102 (e.g., webpage) to the network side system 200. For example, when the browser of the user system loads a page, the trigger 156 can execute one or more function calls to network side system 200 that identifies the document 102. The requests 155 can identify, for example, the URL to the page that is loaded into the web browser. In return, an interface 198 on system 200 handles the requests by determining the fact links that have been associated with the document 102 (e.g., fact links associated with the URL). In particular, the page interface 198 signals the page contents or identifiers 199 for document 102 to the database 160, and retrieves known fact links 145 associated with the particular document. The known fact links 145 for a specific document 102 are then rendered in embedded form with the particular document, in a manner that visually links each embedded fact link 145 to the appropriate statement linked to the fact link. Examples of how fact links can be embedded with a web page are described in greater detail below. In some variations, the rendering of the fact links 145 can include executing widgets or scripts to retrieve real-time data (e.g., stock price), as well as logic for implementing decisions as to credibility, authority or contents of the individual fact links.

In some variations, additional logic, residing with the network system 200, client system 100, or both, can parse, filter or prioritize the fact links that are rendered with a particular document 102. Thus, for example, a given statement on a web page can include several (or hundreds) of embedded fact links 145, and providing all fact links would be not feasible. Network side logic associated with the page interface 198, for example, can select a set of fact links to provide or render with the document 102. The selection of which fact links 145 to send to the client system 100 can be based on one or more criteria, including, for example, (i) authority of authors of the individual fact links 145, (ii) how recent the fact link 145 was generated, and (iii) client or user-specific parameters, such as selecting fact links from persons who are in a social network of the user, or from persons whom the particular user has previously viewed or responded to.

A service interface 144 can receive the fact links 145 that are associated with specific content items on the document 102 (e.g., sentence or phrase). In one implementation, the client presentation component 146 can render the document 102 with the received fact links 145. The presentation component 146 can render the document 102 in a manner that enables the fact links 145 (i) to be spatially positioned near or proximate to the specific content element (e.g., sentence or paragraph, image) that is the basis of the fact link 145, (ii) have multiple modes, and/or (iii) be interactive and responsive to user input and actions. For example, by being interactive, the fact links 145 can be rendered in a manner that can provide for the users to provide input to view the fact link and its comments, provide comment, provide feedback or generate additional fact links. By being interactive, the viewer of the document 102 can view the fact link 145 directly on the page, so that the sentence(s) or phrase(s) that received the fact links 145 can be viewed in context. In some embodiments, the fact links 145 are interactive in a manner that enables the viewer of the document 102 to provide credibility input 185 to the fact link 145 as provided on the page, and/or to create new fact links based on someone else's fact link.

In variations, documents with embedded fact links 145 can include a display mode where the fact links 145 of the document are displayed in a designated region. For example, a side bar can be provided on a web page where fact links are displayed or other visual indications like colors can be used to communicate information about fact links.

In some examples, the fact links 145 can be modal as to display state or interactivity. For example, fact links 145 can be dormant unless triggered to be active. The trigger can be provided by, for example, a user input (e.g., user selects to activate the fact link) or action (e.g., user hovers over a content element that has an embedded fact link). When active, the fact links 145 can also have multiple states of display, such as expanded or contracted (or shortened form).

### EXAMPLES

FIG. 2A-FIG. 2I illustrate interfaces for creating fact links, according to various aspects. In particular, FIG. 2A-FIG. 2I illustrate functionality for enabling a user to select a statement from a content element (e.g., news article, blog etc.) and mark his opinion on the veracity of the statement. An example such as shown by FIG. 2A through FIG. 2E may be implemented through, for example, a browser that is configured to implement a system 100 such as shown by embodiments of FIG. 1A. Accordingly, reference may be made to elements of FIG. 1A for purpose of illustrating a suitable component for performing a step or feature being described.

In FIG. 2A, user views a document corresponding to, for example, a web page. The document can include assertions, corresponding to statements of fact or opinion, about which the user may have his own opinion, such as veracity, credibility or importance. In FIG. 2A, the user highlights the statement using a mouse or pointer. Embedded functionality provided with the browser (e.g., item selector 110) detects the selection of the statement. In FIG. 2B, user interface feature 120 is provided in the form of an overlay feature 202, which can be triggered to display adjacent to a specific content element of interest. In the example provided, the overlay 202 is in the form of a bubble that is near the selected content element.

In FIG. 2C, the overlay 202 can be expanded in response to the user input. When expanded, the overlay 202 can provide the user with a list of options 204 (e.g., menu), and the user can select a feedback from the list of options. As a result, the user is able to interact with the overlay 202. The interaction of the user can correspond to feedback 122. As shown by the example of FIG. 2C, the feedback 122 can pertain to a specific content element, and can be bi- or tri-modal to represent whether the user agrees, is neutral or disagrees. In variations, the user can provide a quantitative input expressing a degree of agreement or disagreement.

In an example depicted by FIG. 2D, the user may select to “agree.” The input can be used create a corresponding fact link. For example, with reference to FIG. 1A, the input can be received as feedback 122, and the linker 130 can create the corresponding fact link 132. Furthermore, the fact link 132 can logically and visually (e.g., through spatial placement) be associated with an underlying content element, shown in FIG. 2D as the selected content element 205. As described further with examples of FIG. 1A and FIG. 1B, the user's browser can communicate the formation of the fact link 132 to a service, and the fact link can optionally be published with other fact links, in fact link channels, on a feed of the user, on the user's social network, etc.

In FIG. 2E, feedback is displayed to the user indicating the creation of a corresponding fact link. For example, a checkmark is displayed in the beginning (or optionally end) of a sentence in the content item, indicating the presence of the fact link 132 about a sentence.

After the fact link 132 is created, FIG. 2F illustrates that the user can elect to preview the fact link 132 on the source document. FIG. 2F further illustrates an embodiment in which graphic features and information can be used to reflect the user's opinion, as well as the user's authority. The user authority can be based on various criteria, such as the number of times other persons have agreed with the particular user's fact link, or provided other credibility input with the user. In the example provided, a graphic feature can use color about a circle to express the summary of all feedback, including opinions, added evidence, and comments. As shown by FIG. 2F, presentation component 146 can include functionality, for example, to render the preview as shown.

FIG. 2G illustrates an example in which the components of the fact link 232 are displayed in a preview overlay. The overlay can display the title of the document on which the fact link 232 is provided, the username of the person who created the fact link, and a time stamp indicating when the fact link 232 was created. The preview can be rendered as an overlay when, for example, the user's pointer moves over the sentence that is associated with a particular fact link 232. The presentation component 146 can be programmed to include, for example, triggers that are responsive to pointer input to generate the overlays.

FIG. 2H illustrates a variation in which a specific fact link 232 is shown with links to other fact links that may support or weaken the position taken by the specific fact link being viewed. For example, a preview panel can show a link to other users who have generated fact links from the same statement of the same article, the same statement from a different article, a similar statement from another source, or from the specific article or source in general. The display of other fact links can identify other users who agree or disagree with the assertion.

FIG. 2I illustrates an example in which a preview panel 240 shows other channels/topics that a particular user is active on. The preview channel 240 can consolidate fact links and underlying elements by topic. The viewer of the fact link 232 can select the links provided, resulting in the user navigating to that specific channel/topic of the inspected user. As an example, when a user just created a fact link himself, it leads to his own page and channels/topics. As another example, when a user comes across another fact link created by another user, it shows the page and channels/topics for that user. This enables user to discover other knowledgeable users.

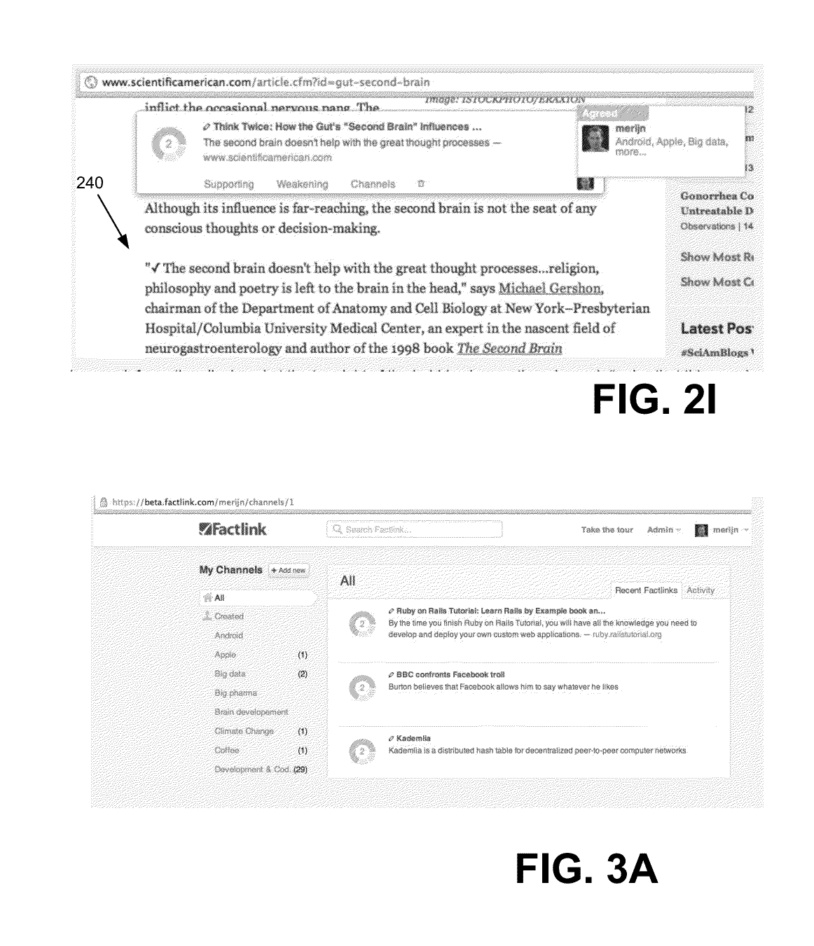

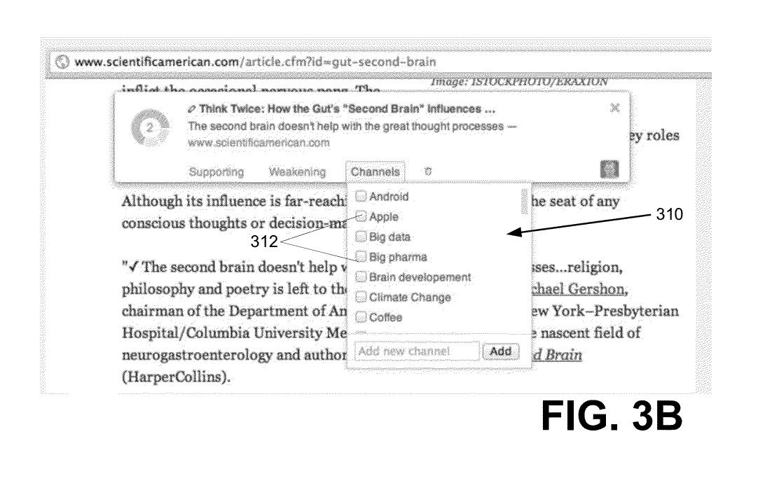

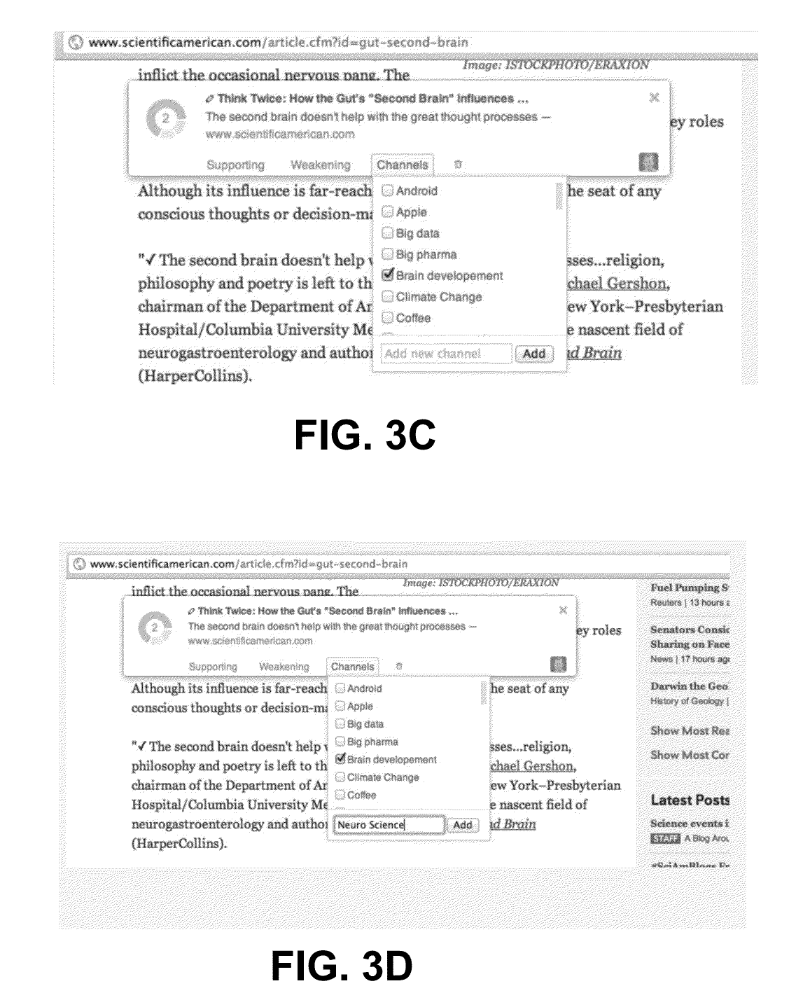

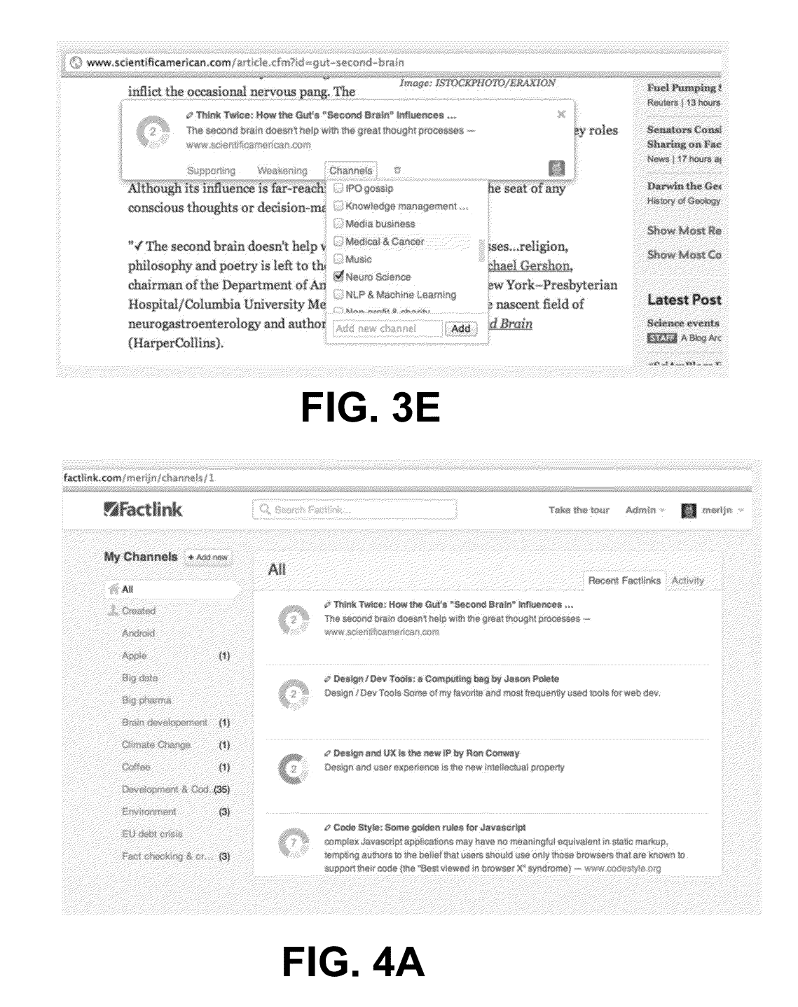

FIG. 3A illustrates a user account page maintained at a service such as described with an embodiment of FIG. 1B. In the example provided, the page can display recent fact links created by the particular user, including information about whether the user agreed or disagreed with the statement, as well as a count as to whether other users of the service agreed or disagreed with the user's own fact link. In variations, more extended user information can also be displayed, such as the specific subject on which that user has authority and the level of authority on each specific subject. The level of authority can be expressed in various forms, and can be based at least in part on the number of other users of the service who created fact links or provided other credibility input that agreed with the opinion of the user regarding a particular fact link of that user. Furthermore, the user page can describe someone's activities and impact on other certain topics.

FIG. 3B to 3E illustrate a user assigning a fact link 132 to a particular channel (or category). In FIG. 3B, the user can trigger a channel menu 310. The items 312 of the channel menu 310 can include topics of interest to the user, and/or topics that the user is deemed to be an authority to, or have at least built authority or provided prior fact links for. In FIG. 3C, the user can select the category. In FIG. 3D, the user can provide additional tags, which can then be displayed in the menu 310 (FIG. 3E). As shown by the example of FIG. 3A through FIG. 3E, the user can access the service, view a recently created fact link, select an existing channel, or create a new channel.

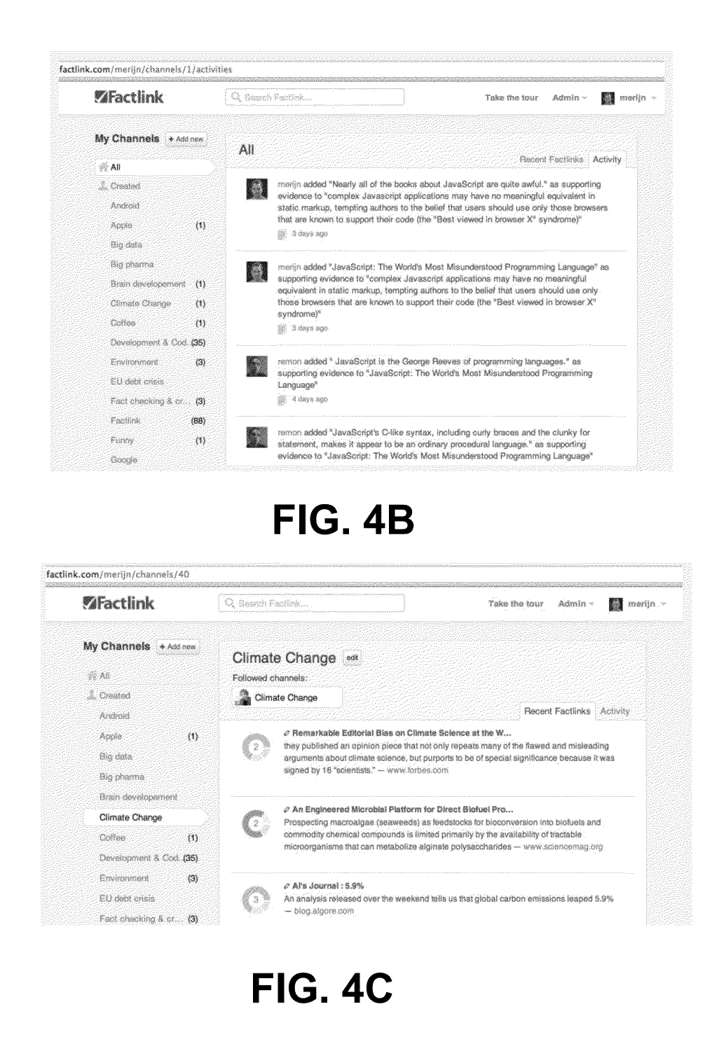

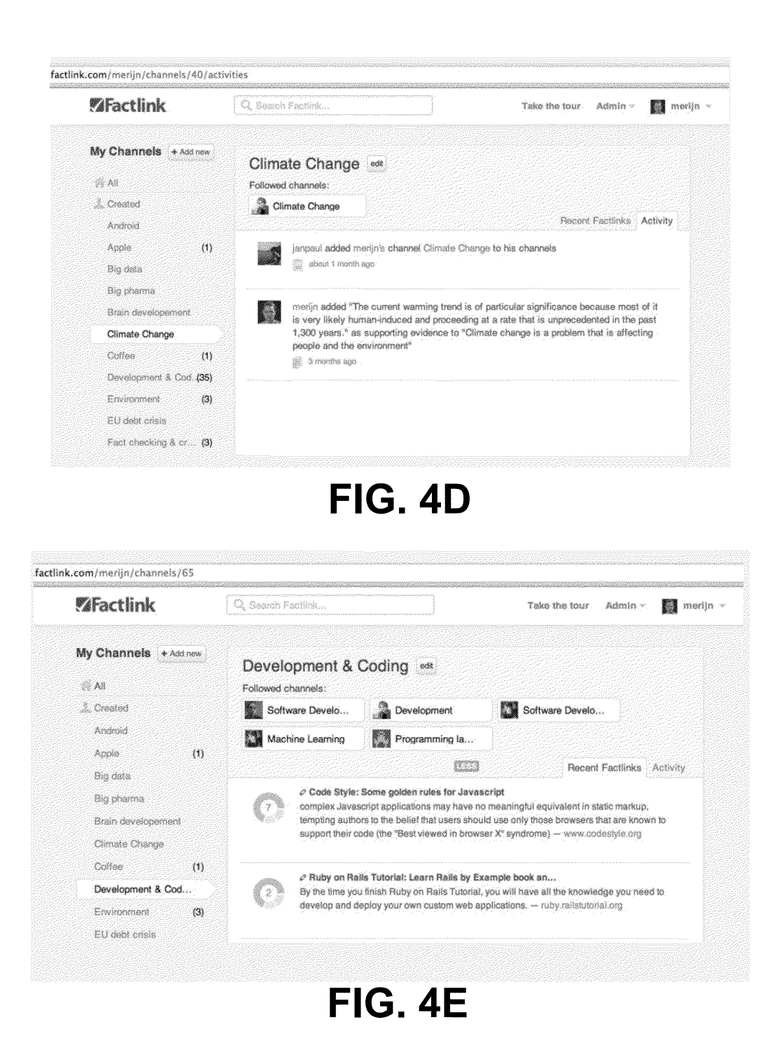

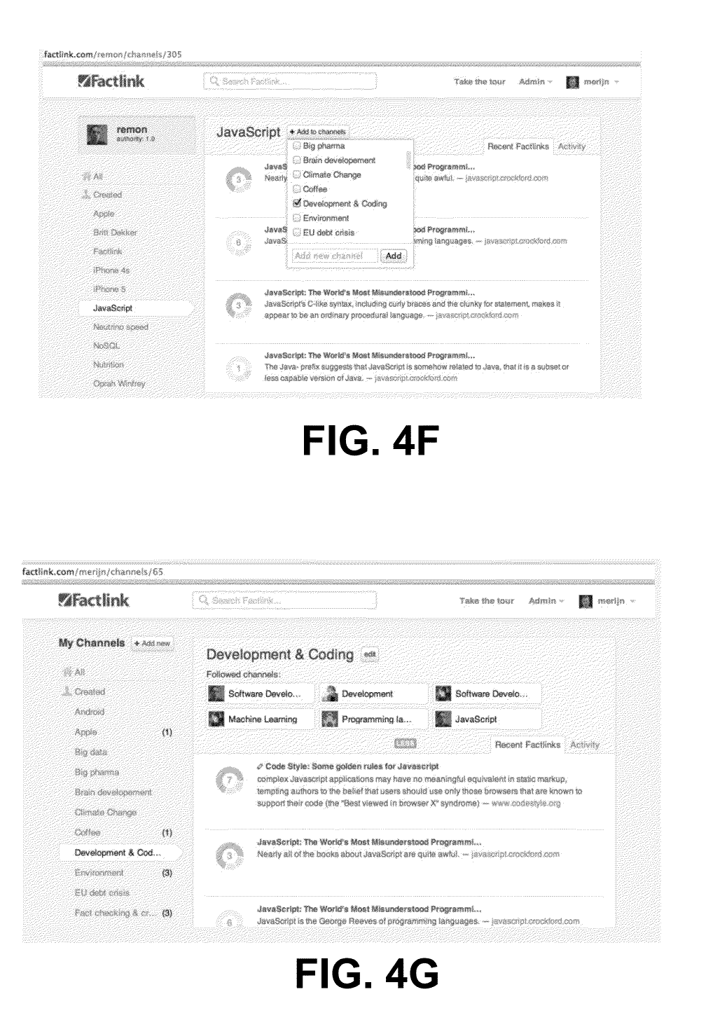

FIG. 4A through FIG. 4G illustrate various examples of interfaces for enabling a user to interact with a fact link or service providing the same. For example, the interfaces depicted by examples of FIG. 4A through FIG. 4G can be used to enable the user to interact with the network system 200. In more detail, FIG. 4A is an example of a user page for interacting with the service 200, under an embodiment. A particular user page may, for example, include the fact link that was last added being at the top of the list/stream. The user page may also provide channel and topics, created or subscribed by the user, covering specific subject matter.

In addition to fact links, FIG. 4B illustrates that the network system 200 (see FIG. 2) may enable the users to add to the authority (e.g., credibility input 185) of their fact links and assertions by identifying other sources that support their position. The credibility input 185 can take the form of a link to another source that displays information supportive of the particular user's position. The supportive assertions can optionally comprise their own stored fact links 181. Other users can also support (or weaken) a particular fact link.

FIG. 4C illustrates use of a fact link stream for a current user's channel/topic (e.g., ‘Climate change’). Fact links related to the topic can be sorted based on ‘Top news’ instead of the show ‘Recent’. In the example provided, the user can also add or follow a channel/topic created by another user as part of his own channel/topic.

FIG. 4D illustrates an example of when another user adds new fact links to his channel/topic, the same fact links will show up in this users channel/topic. The activity tab show another user also added or followed this channel to one of his own channels/topics. This provides another way for the user to discover other users who are interested in the same topics.

FIG. 4E illustrates an example in which a channel/topic (e.g., ‘Development & Coding’) is selected and the list of followed channels/topics is displayed.

FIG. 4F illustrates an example in which a user can access the activities of another user (‘Remon’). Furthermore, the user can select one of the user's channels/topics (‘Javascript’) and then click ‘Add to channels’ in order to add/follow the channel/topic. The followed channel/topic is added to ‘Development & Coding’ in this case.

FIG. 4G illustrates an example of a ‘Development & Coding’ channel of a particular user, after that user added the channel of another user (‘Javascript channel/topic of user Remon) to it. When the user channel adds the channel of another user, fact links that are part of the added channel (e.g., Remon's ‘Javascript’) channel will appear in the user's channel (e.g., ‘Development & Coding’).

As an addition or variation, fact links can be analyzed for topical assignment. Topical assignments can be done programmatically based on a variety of inputs. In one implementation, fact links are analyzed for topic based on how users post other fact links to specific channels. When, for example, multiple people post fact links to topical channels, information provided with posted fact links can be used to determine the topical assignment of the newly identified fact link. For example, fact links relating to a same content element, content item, or author can be similarly assigned to topic.

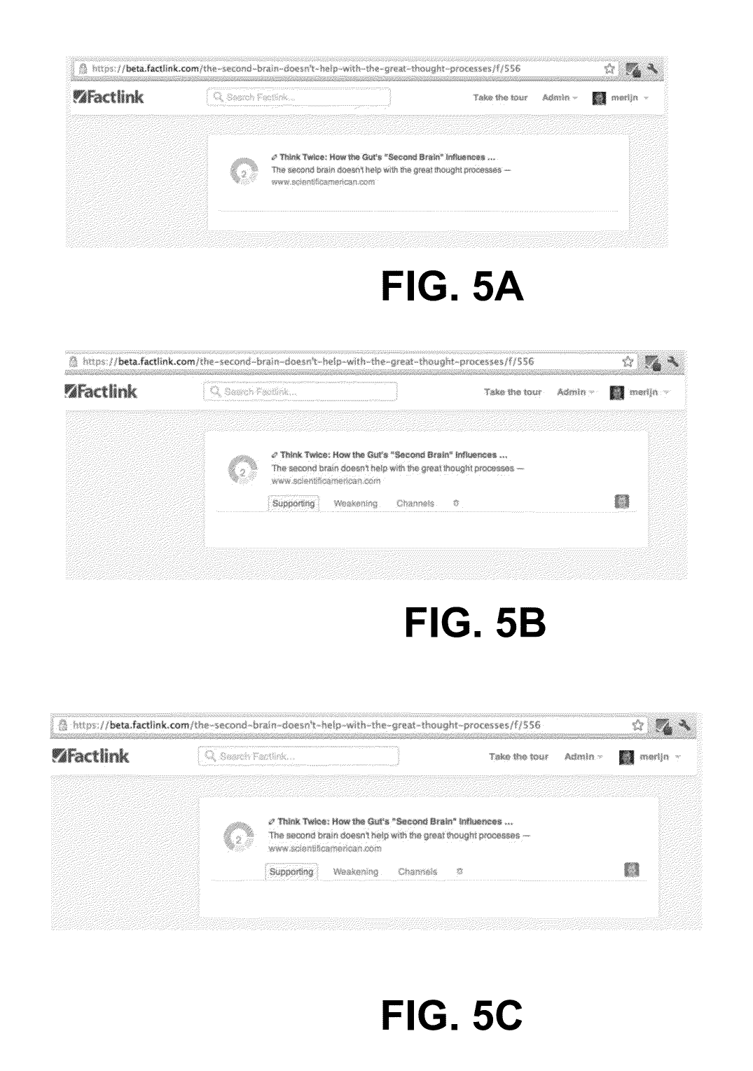

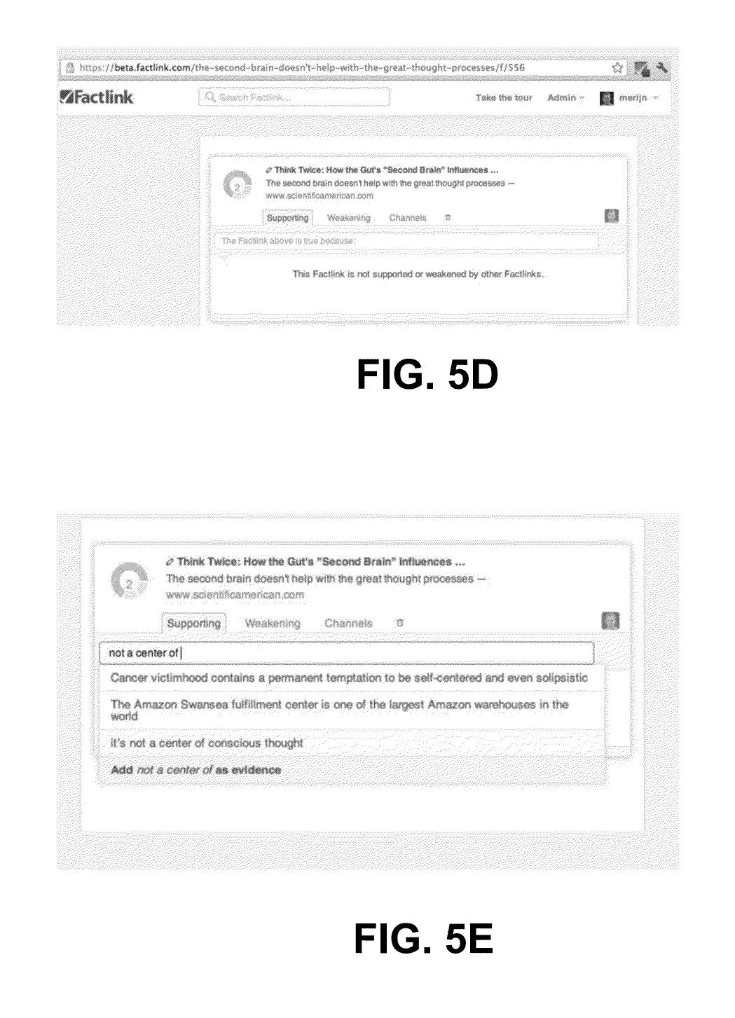

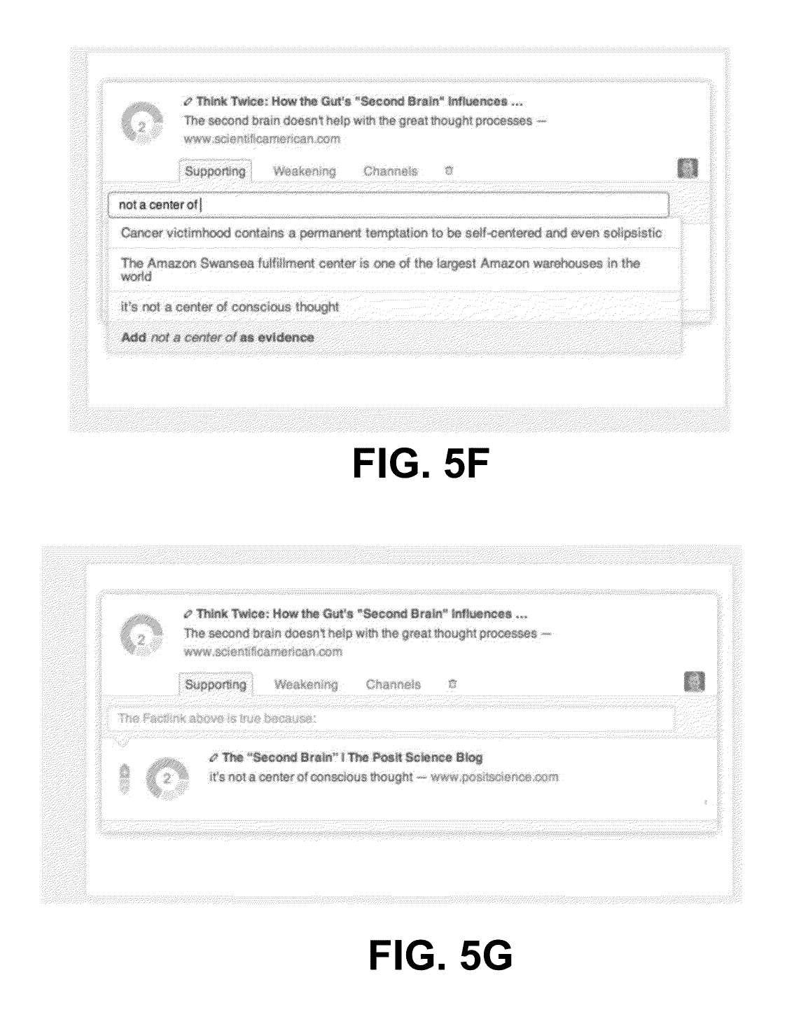

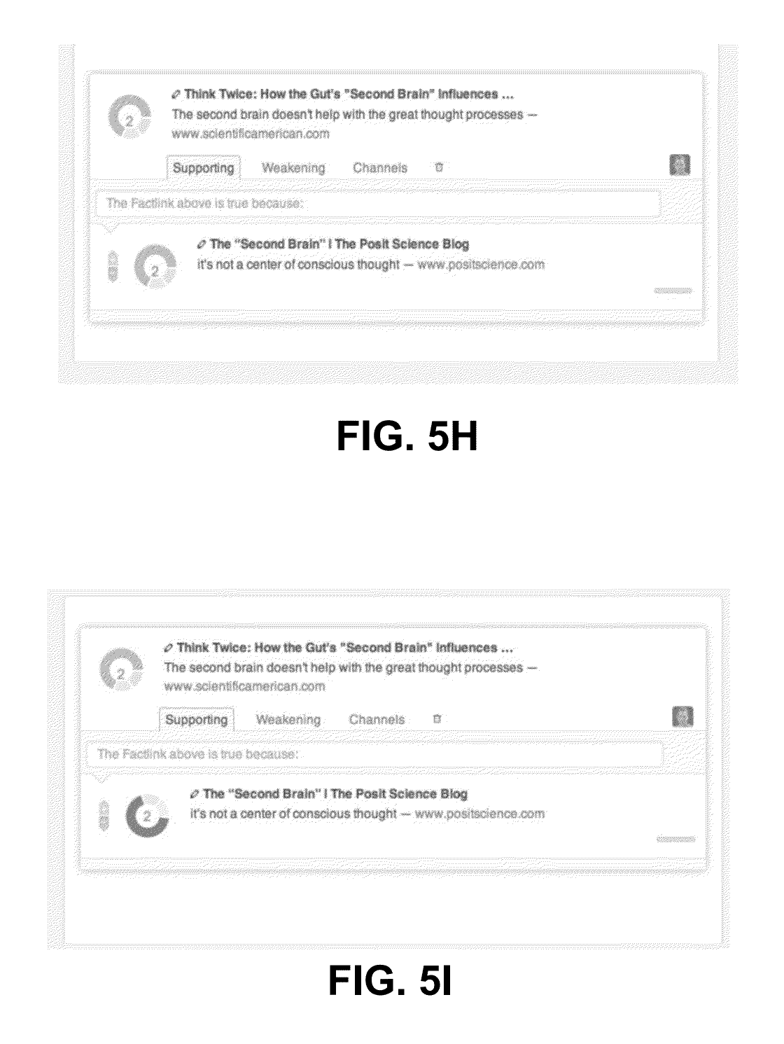

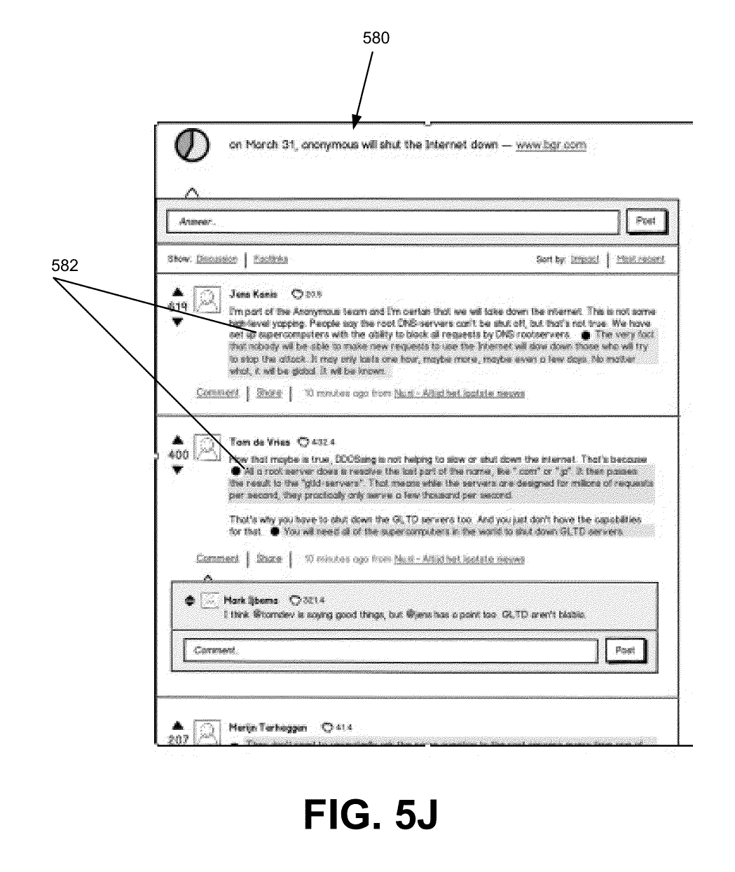

FIG. 5A-5E illustrate examples in which evidence can be provided to support or weaken a fact link. A fact link can be inspected on its own fact link page, which can display the history of the fact link and show a graph of the credibility as the credibility changes over time, as well as the users that had most impact on the fact link (which provides a discovery option for the user to find new users and thereby new fact links, channels/topics, and pages/documents they are used in).

With reference to FIG. 5B, service 200 can display ‘tabs’ for ‘Supporting’, ‘Weakening’ and ‘Channels’. These tabs enable the user to inspect how Fact links are supported or weakened by other fact links (‘evidence’) (e.g., see also credibility input 185 of FIG. 1B).

In the example shown by FIG. 5C and FIG. 5D, when the ‘Support’ tab is clicked, the fact links that support the main or underlying fact link are displayed, sorted by impact on the credibility of the main fact link. In the example shown, no supporting Fact links have been added yet. In FIG. 5E, the user can specify evidence in support or against the position of the fact link.

FIG. 5F illustrates an interface in which a user is enabled to enter text that can be used as a supporting fact link. This action can optionally create a fact link. In this case, the use starts typing: ‘not a center of conscious thinking’ but discovers that a fact link on this subject already exists: the last item in the list ‘it's not a center of conscious thought’ is a fact link that is about the main fact link and supports it. The example provided by FIG. 5F illustrates that the service 200 can perform a search (e.g., key by key search) of fact links to facilitate the identification of fact links that pertain to the same statement or assertion.

FIG. 5G illustrates the case where the supporting fact link has been selected and is now displayed as part of the list of supporting fact links. The circle in front of the supporting fact link can be used by other users to “agree” or “disagree” with the assertion of the fact link that is displayed as supporting. The arrows in front of the supporting fact link can be used by users to indicate if the particular user agrees whether the fact link is actually supporting the main fact link.

FIG. 5G illustrates the function in which any user can agree or disagree with the listed fact link as supporting for the main fact link. The supporting fact link indicates agreement or disagreement using the arrows and the circle provided with the fact link. In FIG. 5F, the user has changed his opinion from the previous slide and selected the down-arrow to indicate he beliefs the fact link is not supporting the main fact link.

In FIG. 5H, the example is continued in showing the user has indicated his belief that the supporting fact link is also false. A graphic bar at the right of the supporting fact link indicating the impact of the supporting fact link on the main fact link.

FIG. 5I illustrates a variation in which fact links can be combined with arguments. Arguments can be expressive data that is provided by the population of users based on an original fact link 580. Arguments include ‘blocks’ or ‘paragraphs’ of text that can be a combination of fact linked text and ‘normal’ text. An argument 582 can consist of any one or more of a fact link, or normal text or combinations of fact links and text. There can be comments on arguments. The text provided as argument can be either supporting or weakening. Arguments can also be scored, based on feedback each argument receives. The arguments can be sorted accordingly, and further provided with graphic indicators showing the strength of each argument. Optionally, the user can see how much each argument contributes to the total impact on the main fact link.

Methodology

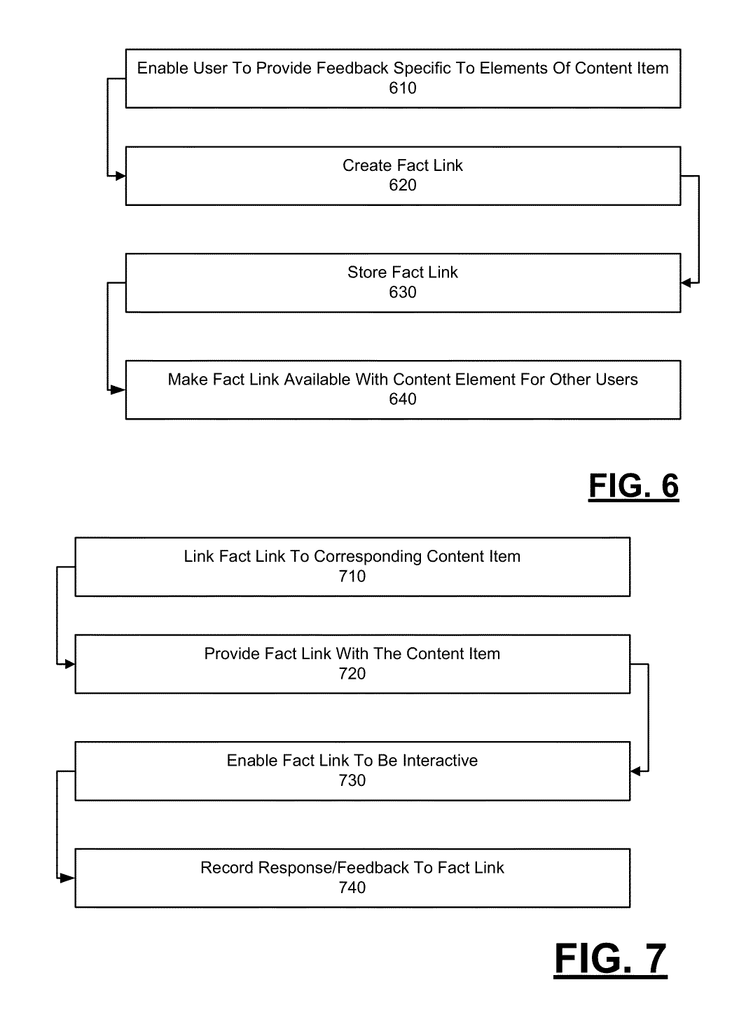

FIG. 6 illustrates a method in which a fact link can be created for a content item, according to an embodiment. FIG. 7 illustrates a method for providing fact links to a population of users, according to an embodiment. In describing examples of FIG. 6 and FIG. 7, reference may be made to elements of FIG. 1A or FIG. 1B for purpose of illustrating suitable components for performing a step or sub-step being described.

In FIG. 6, the user is enabled to provide feedback that is specific to elements of a content item (610). For example, the user can provide feedback as to a sentence, paragraph or image of a web page. The feedback can thus resemble an annotation. In order to enable the user to provide the feedback, the content item may be rendered in a manner that enables specific elements of the content item to be selectable. Moreover, additional functionality can trigger an interface to appear with content elements in order to allow for the feedback. In FIG. 1A, for example, the user interface 120 can be implemented in connection with a web page or other document 102 to enable the user to select specific elements. In FIG. 1B, the presentation component 180 can be operated with or in connection with a web page, for example, to enable the user to provide feedback as to specific content elements.

In response to the user feedback, the fact link is created (620). In one implementation, the fact link includes a selection input (e.g., good, bad, neutral). Additionally, the fact link can include metadata that identifies the content item, the content element receiving the feedback, and the author of the fact link.

The fact link can then be stored (630). In particular, the fact link may be stored for viewing by other users. For example, the network system 200 can store the fact links via the database 160.

Once stored, the fact link can be made available for other users (640). Other users can view the fact link directly (without the underlying content), or view the fact link when viewing the content item. When rendered with the content item, the fact link can be visually linked to the element that is the subject of the fact link. Still further, in some variations, the fact link can be linked with the underlying content element, and made available when the content element is re-published or used. For example, the content element can be a quote that is reproduced in other articles, or in social media. The fact links associated with the content element can be displayed, even if the fact links were generated from a different content item where the element previously appeared.

With reference to FIG. 7, the network system 200 can link a given fact link to a corresponding content item or element (710). For example, the fact link can be linked to an article, or to a quote in an article. Subsequently, when the content item is rendered (e.g., web page), the associated fact links to the content item can be made available for viewing with the content item (720). For example, the associated fact links can be embedded in the page, and may be triggered into various states of display. In variations, the fact links can be associated with specific content elements and triggered into display when the content element is published (with the original content item or elsewhere).

When the fact link is provided, embodiments provide that it is in form of an interactive element (730). For example, the viewer can provide feedback to the fact link, create additional fact links to the fact link, or otherwise include commentary etc. In a web page, the fact link can, for example, appear as an overlay or annotation that the user can submit response to.

The response to the fact link may be recorded. In one implementation, the network system 200 stores responses to fact links in the fact link database. The responses to the fact link can be used to determine credibility of the fact link, of the author of the fact link, or of the source/author of the underlying content item or element.

Implementation Models

Various alternative models can be used to implement fact links. Among them, fact links can be provided as an enterprise (or local area network) tool that can enable fact link generation for documents in a manner that enables the documents to be internal to the enterprise network. Such fact links can be deemed private status or private fact links.

In variations, such fact links can be used with public fact links. Public fact links can be used to support private fact links in a manner that maintains the private fact links private.

Still further, some variations enable private fact links to be shared as a channel or other group share format.

Still further, publishers can be enabled to have selected ability to publish articles or content items with fact links enabled in full or part.

Still further, in some examples, fact links can be used to enhance or augment general search results. For example, topical assignments of fact links can affect ranking and subject matter determination when search results are provided.

Computer System

Examples described herein provide that methods, techniques and actions performed by a computing device are performed programmatically, or as a computer-implemented method. Programmatically means through the use of code, or computer-executable instructions. A programmatically performed step may or may not be automatic.

Examples described herein may be implemented using programmatic modules or components. A programmatic module or component may include a program, a subroutine, a portion of a program, or a software component or a hardware component capable of performing stated tasks or functions. As used herein, a module or component can exist on a hardware component independently of other modules or components. Alternatively, a module or component can be a shared element or process of other modules, programs or machines.

Furthermore, examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, examples may be implemented in the form of computer-programs, or a computer usable carrier medium capable of carrying such a program.

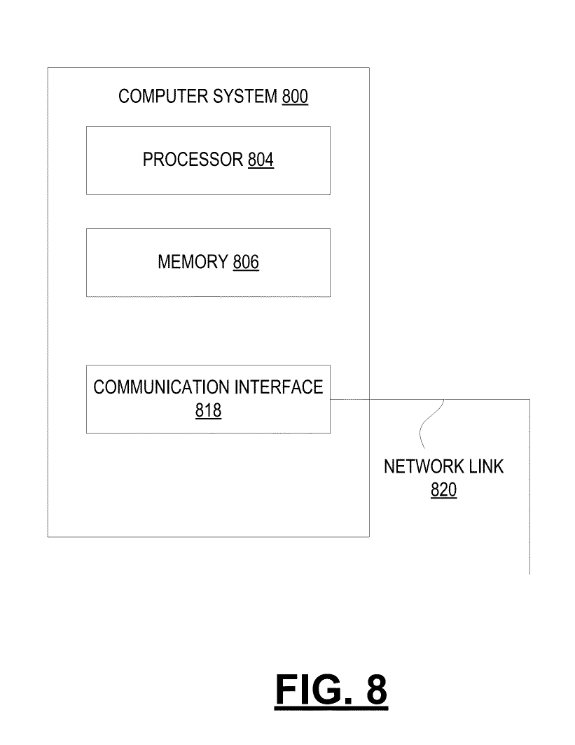

FIG. 8 is a block diagram that illustrates a computer system upon which aspects described herein may be implemented. For example, in the context of client system 100 of FIG. 1A or network system 200 of FIG. 1B.

In one implementation, computer system 800 includes processor 804, memory 806 (including non-transitory memory), and communication interface 818. Computer system 800 includes at least one processor 804 for processing information. Computer system 800 also includes a memory 806, such as a random access memory (RAM) or dynamic storage device, for storing information and instructions to be executed by processor 804. The memory 806 also may be used for storing temporary variables or other intermediate information during execution of instructions to be executed by processor 804. Computer system 800 may also include a read only memory (ROM) or other static storage device for storing static information and instructions for processor 804. The communication interface 818 may enable the computer system 800 to communicate with a network, or a combination of networks, through use of the network link 820 (wireless or wireline).

Examples described herein are related to the use of computer system 800 for implementing the techniques described herein. According to one aspect, those techniques are performed by computer system 800 in response to processor 804 executing one or more sequences of instructions contained in memory 806. Such instructions may be read into memory 806 from another machine-readable medium, such as storage device 810. Execution of the sequences of instructions contained in memory 806 causes processor 804 to perform the process steps described herein. In alternative implementations, hard-wired circuitry may be used in place of or in combination with software instructions to implement examples such as described herein. Thus, examples as described are not limited to any specific combination of hardware circuitry and software.

Although illustrative examples have been described in detail herein with reference to the accompanying drawings, variations to specific aspects and details are encompassed by this disclosure. It is intended that the scope described herein can be defined by claims and their equivalents. Furthermore, it is contemplated that a particular feature described, either individually or as part of an example, can be combined with other individually described features, or parts of other examples. Thus, absence of describing combinations should not preclude the rights to such combinations.

What is claimed is:

1. A method for monitoring credibility of online content, the method being implemented by one or more processors and comprising:
enabling a user to interact with an element of a content item, the element conveying an assertion;
in response to the user interacting with the element of the content item, generating a user interface feature that enables the user to enter feedback regarding the user's belief in the veracity or credibility of the assertion conveyed by the element of the content item;
creating a fact link that associates the element of the content item with the feedback; and
storing the fact link.

2. The method of claim 1, wherein the content item includes an article, and wherein the fact link is spatially linked with the content element that conveys the assertion, the content element corresponding to one or more sentences or phrases that are part of the content item.

3. The method of claim 1, further comprising associating the fact link with the content item, and enabling the fact link to be viewed by other users who render the content item.

4. The method of claim 3, wherein enabling the fact link to be viewed includes rendering the fact link with the content item for the other users, the fact link being positioned spatially adjacent to the content element that conveys the assertion.

5. The method of claim 1, wherein the element of the content item corresponds to an image, and wherein the fact link can represent the belief of the user in the veracity or credibility of the assertion conveyed by the image.

6. The method of claim 1, further comprising enabling other users to provide feedback on the fact link.

7. The method of claim 6, wherein the feedback includes (i) a binary or trinary input as to whether a given one of the other users considers the created fact link to be true or false, (ii) a comment about the created fact link, or (iii) a fact link on a fact link.

8. The method of claim 6, further comprising calculating a credibility of the fact link based on a totality of the feedback received from the other users.

9. The method of claim 6, further comprising calculating a credibility of the user of the fact link based on a totality of the feedback received from the other users.

10. A method for publishing credibility of online content, the method being implemented by one or more processors and comprising:
linking a fact link to a content item, the fact link being associated with an assertion of the content item;
providing the fact link with the content item, so that the fact link can be viewed adjacent or near the assertion of the fact link; and
enabling the fact link to be interactive to receive feedback from a user viewing the content item.

11. The method of claim 10, further comprising detecting a user in a population of users that views the content item and interacts with the fact link by providing feedback for the fact link.

12. The method of claim 11, further comprising storing the feedback provided by the user who interacts with the fact link, then providing the fact link with the content item and including the feedback provided by the user who interacted with the fact link when the content item is subsequently rendered to other users in the population of users.

13. The method of claim 11, wherein the feedback can correspond to one or more of a binary input indicative of a belief of the user providing feedback as to the credibility or veracity of the fact link, a comment, or a fact link on the fact link.

14. The method of claim 10, wherein providing the fact link includes rendering the fact link with a graphic that indicates a totality of the feedback that the fact link has received from a population of users.

15. The method of claim 14, further comprising calculating a credibility of one or more of (i) an author of the fact link, (ii) the fact link, or (iii) the user providing the feedback, based on the feedback.

16. The method of claim 15, further comprising providing the fact link with a visual indicator of the calculated credibility for the fact link.
